(19) United States
(12) Patent Application Publication
(10) Pub. No.: US 2008/0137818 A1
(43) Pub. Date: Jun. 12, 2008

(54) Call management methods and systems

(75) Inventor: Fu-Chiang Chou, Taoyuan (TW)

Correspondence Address: BIRCH STEWART KOLASCH & BIRCH, PO BOX 747, FALLS CHURCH, VA, 22040-0747, US

(73) Assignee: HIGH TECH COMPUTER, CORP.

(21) Appl. No.: 11/882,949

(22) Filed: Aug. 7, 2007

(30) Foreign Application Priority Data
Dec. 12, 2006 (TW) 95146440

(51) Int. Cl. H04M 1/64; G10L 13/00

(52) U.S. Cl. 379/88.17; 704/258; 704/E19.007

(57) ABSTRACT

Call management methods and systems for use in a device having telecommunication capability. At least one communication event comprising a phone number, first communication content and communication time is provided. At the communication time, a call is made according to the phone number. A first communication voice is generated using a text-to-speech technology according to the first communication content, and provided to at least one participant of the call.

### BACKGROUND OF THE INVENTION

1. Field of the Invention

The disclosure relates generally to call management methods and systems, and, more particularly to call management methods and systems using voice technologies.

2. Description of the Related Art

Recently, portable devices, such as handheld devices, have become more and more advanced and multifunctional. For example, a handheld device may provide communication capability, global positioning function, email access, advanced address book management, media playback, Internet access capability, and various other applications. With the convenience of the functions and devices, handheld devices have become important tools for everyday life.

In current use, handheld device users may constantly make a number of routine outbound calls. For example, users may confirm meetings, check on family members, make reservations, order meals, return calls, and others. Users spend considerable time performing these repetitive and often mundane tasks. In addition to time and money, these tasks may also hinder their completion of more meaningful work. As described, since handheld devices are becoming more advanced and multifunctional and users often lead demanding lives, there is a need to minimize the inconvenience associated with making routine calls.

### BRIEF SUMMARY OF THE INVENTION

Call management methods and systems are provided.

In an embodiment of a call management method for use in a device having telecommunication capability, at least one communication event comprising a phone number, first communication content and communication time is provided. At the communication time, a call is made according to the phone number. A first communication voice is generated using a text-to-speech technology according to the first communication content, and provided to at least one participant of the call.

In an embodiment of a call management method for use in a device having telecommunication and positioning capabilities, at least one communication event comprising a phone number, first communication content and communication location is provided. A position of the device is obtained. If the position conforms to the communication location, a call is made according to the phone number. A first communication voice is generated using a text-to-speech technology according to the first communication content, and provided to at least one participant of the call.

An embodiment of a call management system comprises at least one communication event comprising a phone number, first communication content and communication time, and a processing unit. At the communication time, the processing unit makes a call according to the phone number. The processing unit generates a first communication voice using a text-to-speech technology according to the first communication content, and provides the first communication voice to at least one participant of the call.

An embodiment of a call management system comprises at least one communication event comprising a phone number, first communication content and communication location, a positioning unit and a processing unit. The processing unit obtains a position via the positioning unit, and determines whether the position conforms to the communication location. If so, the processing unit makes a call according to the phone number. The processing unit generates a first communication voice using a text-to-speech technology according to the first communication content, and provides the first communication voice to at least one participant of the call.

Call management methods and systems may take the form of program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a call management system;

FIG. 2 is a schematic diagram illustrating another embodiment of a call management system;

FIG. 3 is a flowchart of an embodiment of a call management method;

FIG. 4 is a flowchart of an embodiment of a call management method;

FIG. 5 is a flowchart of an embodiment of a call management method for confirming meetings;

FIGS. 6A and 6B are flowcharts of an embodiment of a call management method for checking on family members; and

FIG. 7 is a flowchart of an embodiment of a call management method for ordering meals.

### DETAILED DESCRIPTION OF THE INVENTION

Call management methods and systems are provided.

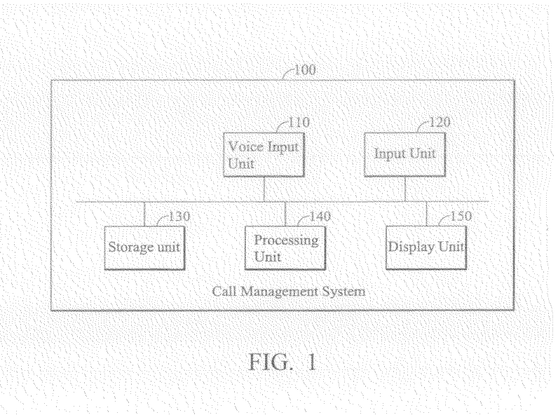

FIG. 1 is a schematic diagram illustrating an embodiment of a call management system.

The call management system 100 may be a device having telecommunication capability, such as a fixed phone or a mobile phone. The call management system 100 comprises a voice input unit 110, an input unit 120, a storage unit 130, a processing unit 140, and a display unit 150. It is understood that the call management system 100 further comprises a communication module (not shown) such as base band and RF (Radio Frequency) modules for implementing communications. The voice input unit 110 may be a microphone. The input unit 120 may be a keypad on the device. The storage unit 130 may be a built-in memory of the device, or an external memory card. The storage unit 130 comprises one or more communication events, each comprising a phone number of a participant, communication content, and communication time. Note that the content of respective communication events can be generated in advance, or at the communication time. Additionally, the phone number can be directly set in the communication event, or retrieved from an address book according to the ID of the participant. The communication content may be details and data needed for the purpose of the communication, such as confirming meetings, checking on family members, making reservations, ordering meals, returning calls, and related subsequent processes. The use of the communication events is discussed later. The processing unit 140 controls operation of components of the call management system 100, and performs the call management method. The display unit 150 may be a screen of the device for display related information.

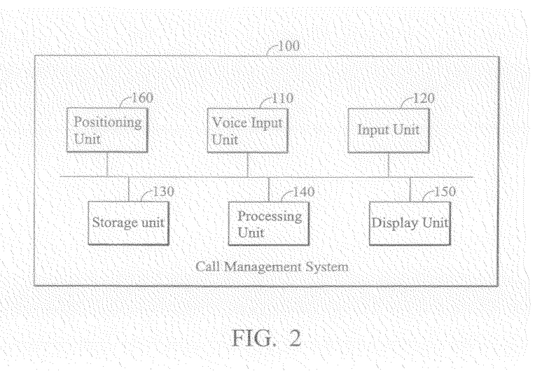

FIG. 2 is a schematic diagram illustrating another embodiment of a call management system. In addition to the components in FIG. 1, a positioning unit 160 such as a GPS (Global Positioning System) is provided. The positioning unit 160 receives signals from a plurality of satellites, and calculates position information of the device accordingly. In this embodiment, the communication event comprises a phone number of a participant, communication content, and a specific communication location. If the call management system 100 approaches or reaches at the communication location, a call is placed according to the phone number recorded in the communication event.

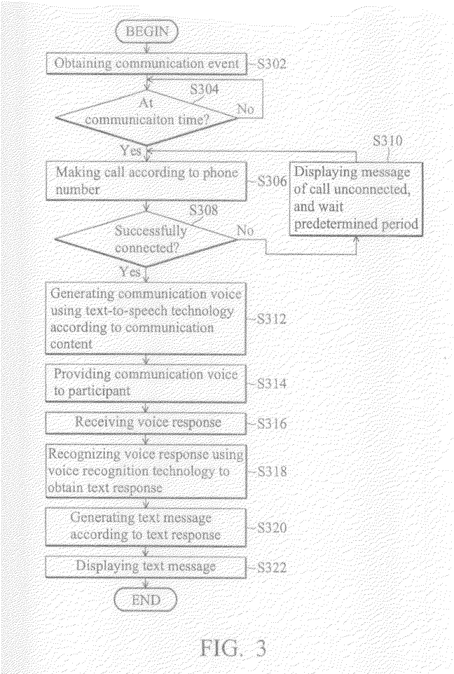

FIG. 3 is a flowchart of an embodiment of a call management method.

In step S302, a communication event is obtained from the storage unit 130. The communication event comprises a phone number, communication content, communication time, and others. As described, the content of respective communication events can be generated in advance, or at the communication time. In step S304, it is determined whether the communication time is present. If not, the procedure remains at step S304. If so, in step S306, a call is made according to the phone number recorded in the communication event. It is understood that if the participant ID is recorded in the communication event, the phone number can be retrieved from the address book according to the participant ID. In step S308, it is determined whether the call is successfully connected (established), that is to determine whether the call goes through to the participant. If not, in step S310, a text message representing or confirming that the call is not connected is displayed via the display unit 150, and returns to step S306 after a predetermined period. If so, in step S312, a communication voice is generated using a text-to-speech technology according to the communication content in the communication event, and in step S314, provided to the participant of the call.

In some embodiments, the participant can respond for the communication voice. It is understood that the communication voice may comprise a prompt instructing the participant to respond after a specific notification such as a beep. The call management system 100 can receive the response from the participant after the beep. In step S316, a voice response is received from the participant. In step S318, the voice response is recognized using a voice recognition technology to obtain a text response. In step S320, a text message is generated according to the text response, and in step S322, displayed via the display unit 150 notifying the user of the response from the participant.

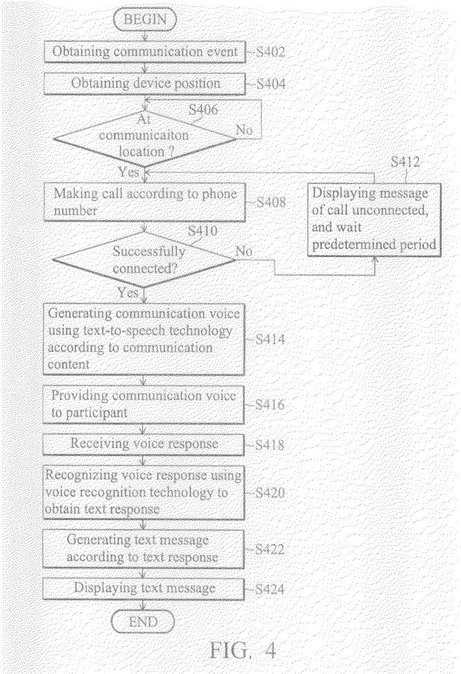

FIG. 4 is a flowchart of an embodiment of a call management method.

In step S402, a communication event is obtained from the storage unit 130. The communication event comprises a phone number, communication content, communication location, and others. In step S404, a position of the device is obtained via the positioning unit 160. In step S406, it is determined whether the device position conforms to the communication location. That is to determine whether the device is at the communication location. If not, the procedure remains at step S404. If so, in step S408, a call is made according to the phone number recorded in the communication event. In step S410, it is determined whether the call is successfully connected. If not, in step S412, a text message representing the call is not connected is displayed via the display unit 150, and returns to step S408 after a predetermined period. If so, in step S414, a communication voice is generated using a text-to-speech technology according to the communication content in the communication event, and in step S416, provided to the participant of the call via the communication module. In step S418, a voice response is received from the participant. In step S420, the voice response is recognized using a voice recognition technology to obtain a text response. In step S422, a text message is generated according to the text response, and in step S424, displayed via the display unit 150 notifying the user of the response from the participant. It is understood that the difference between the embodiments in FIG. 3 and FIG. 4 is the trigger to make a call, where a specific communication time acts as a trigger in FIG. 3, and a specific communication location acts as a trigger in FIG. 4. In the following embodiments, a call is made according to communication time. However, the call can be also made based on a communication location.

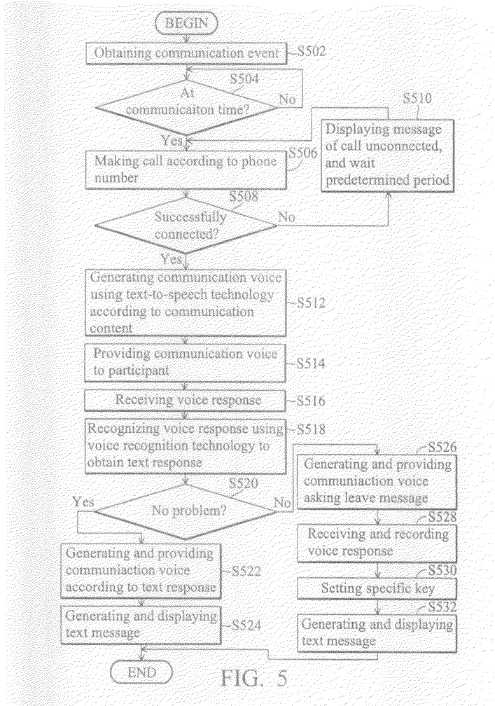

FIG. 5 is a flowchart of an embodiment of a call management method for confirming meetings. In this embodiment, Jack and Michael have a meeting at 10:30 AM, and Jack would like to confirm the meeting at 10:00 AM.

In step S502, a communication event is obtained from the storage unit 130. The communication event comprises a phone number, communication time, and communication content corresponding to meeting confirmation. It is noted that the communication time can be set as absolute time such as 10:00, or relative time such as 30 minutes prior to meeting time. The meeting time can be retrieved from a calendar/schedule, and the communication time can be calculated accordingly. In step S504, it is determined whether the communication time is present. If not, the procedure remains at step S504. If so, in step S506, a call is made according to the phone number recorded in the communication event. In step S508, it is determined whether the call is successfully connected. If not, in step S510, a text message representing the call is not connected is displayed via the display unit 150, and returns to step S506 after a predetermined period such as 10 minutes.

If so, in step S512, a communication voice is generated using a text-to-speech technology according to the communication content in the communication event, and in step S514, provided to the participant of the call. In this embodiment, the communication voice may be “Michael, You and Jack will have a meeting at 10:30. Jack would like to confirm the meeting with you. Do you have any problem with the meeting? Please say yes or no after the beep”. In step S516, a voice response is received from Michael. In step S518, the voice response is recognized using a voice recognition technology to obtain a text response. It is understood that several subsequent processes can be defined for different text responses, and one of the subsequent process is selected according to the text response corresponding to the received voice response. If the text response is “No” (Yes in step S520), in step S522, communication voice, such as “Thanks, I'll inform Jack that you have no problem with the meeting. Jack will join the meeting at 10:30 AM on time. Bye” is generated and provided to Michael according to the text response. In step S524, a text message, such as “Michael said that there is no problem with the meeting” is generated according to the text response, and displayed via the display unit 150. If the text response is “Yes” (No in step S520), in step S526, communication voice, such as “Thanks. Please leave a message after the beep, telling your problem to Jack” is generated and provided to Michael according to the text response. In step S528, a voice response is received and recorded from Jack. In step S530, a specific key such as <1> key of the input unit 120 is set, where the voice response is played back if a keystroke corresponding to the specific key is received. In step S532, a text message, such as “Michael said that there is a problem with the meeting. Please press <1> for the attached message” is generated according to the text response, and displayed via the display unit 150.

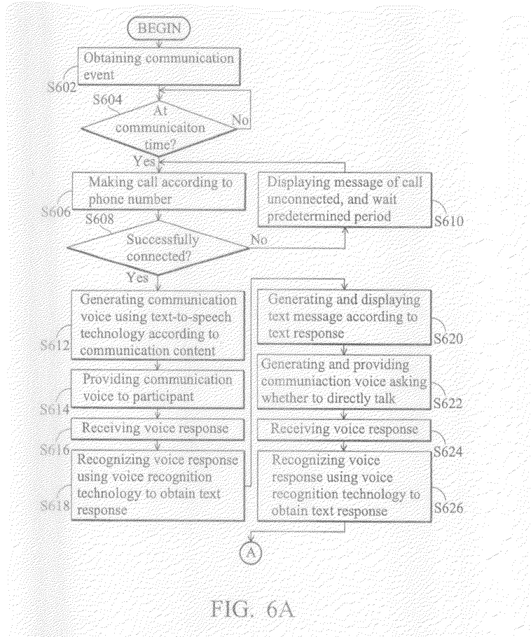

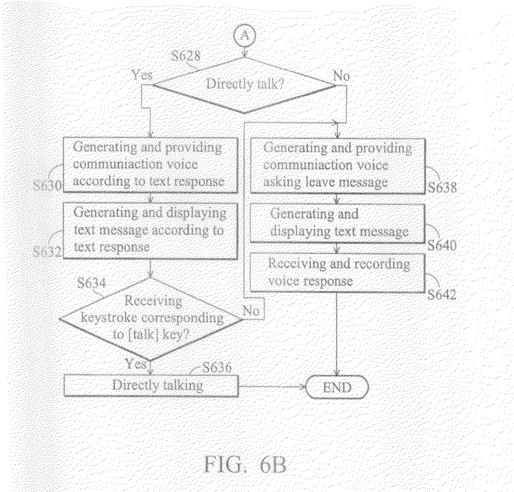

FIGS. 6A and 6B are flowcharts of an embodiment of a call management method for checking on family members. In this embodiment, Jack must contact his daughter (Mary) at 4:30 PM, and confirm her location.

In step S602, a communication event is obtained from the storage unit 130. The communication event comprises a phone number, communication time such as 4:30 PM, and communication content corresponding to location confirmation. In step S604, it is determined whether the communication time is present. If not, the procedure remains at step S604. If so, in step S606, a call is made according to the phone number recorded in the communication event. In step S608, it is determined whether the call is successfully established. If not, in step S610, a text message representing the call is not connected is displayed via the display unit 150, and returns to step S606 after a predetermined period such as 10 minutes.

If so, in step S612, a communication voice is generated using a text-to-speech technology according to the communication content in the communication event, and in step S614, provided to the participant of the call via the communication module. In this embodiment, the communication voice in step S614 may be “Mary, Your father would like to confirm your location. Are you at school, home, or the way home?” In step S616, a voice response is received from Mary. In step S618, the voice response is recognized using a voice recognition technology to obtain a text response. In step S620, a text message is generated and displayed via the display unit 150 according to the text response, and in step S622, communication voice is generated and provided to the participant. For example, if the text response is “home”, the text message may be “Your daughter is at home. Press [talk] to talk to her, or let her leave a message”. Simultaneously, the communication voice may be “OK! I'll tell your father you are at home. Do you want to talk to him?” In step S624, another voice response is received from Mary. In step S626, the voice response is recognized using the voice recognition technology to obtain another text response. If the text response is “Yes” (Yes in step S628), in step S630, communication voice, such as “OK! I'll inform your father that you would like to talk to him. Please wait.” is generated and provided to Mary according to the text response. In step S632, a text message, such as “Your daughter wants to talk to you. Press [talk] to talk to her, or let her leave a message” is generated and displayed via the display unit 150 according to the text response. If a keystroke corresponding to the [talk] key is received (Yes in step S634), in step S636, Jack can directly talk to Mary. If no keystroke corresponding to the [talk] key is received (No in step S634), or the text response is “No”, in step S638, communication voice, such as “Please leave a message after the beep” is generated and provided to Mary, and in step S640, a text message, such as “Asking your daughter to leave a message” is generated and displayed via the display unit 150. In step s642, a voice response is received and recorded from Mary.

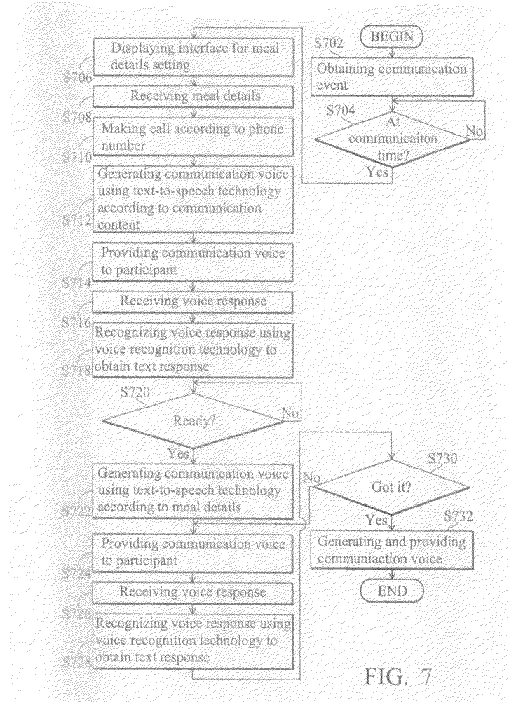

FIG. 7 is a flowchart of an embodiment of a call management method for ordering meals. In this embodiment, Jack wants to order a meal with a specific restaurant at 6:30 PM.

In step S702, a communication event is obtained from the storage unit 130. The communication event comprises a phone number of the specific restaurant, communication time, and communication content corresponding to meal ordering. In step S704, it is determined whether the communication time is present. If not, the procedure remains at step S704. If so, in step S706, at least one interface setting meal details is displayed. The interface can record meals provided by the restaurant. In step S708, selections and settings for meals are received via the interface. It is understood that the interface may ask a confirmation from user to order a meal before the meal selection and setting, and if so, the selection and setting for meals are performed. In step S710, a call is made according to the phone number recorded in the communication event. In step S712, a communication voice is generated using a text-to-speech technology according to the communication content in the communication event, and in step S714, provided to the participant of the call via the communication module. In this embodiment, the communication voice in step S714 may be “I'm Jack's secretary. I want to make an order for him. Are you ready? If so, please say yes after the beep.” In step S716, a voice response is received from a participant such as a restaurant clerk. In step S718, the voice response is recognized using a voice recognition technology to obtain a text response. If the text response is “Yes” (Yes in step S720), in step S722, communication voice is generated according to the communication content (meal details set via the interface) using a text-to-speech technology, and in step S721, provided to the participant via the communication module. For example, the communication voice may be “He wants to order one creamy mustard chicken with hot coffee. Say yes to confirm.” In step S726, a voice response is received from the clerk, and in step S728, the voice response is recognized using the voice recognition technology to obtain a text response. If the text response is not “Yes” (No in step S730), the procedure returns to step S724. If the text response is “Yes” (Yes in step S730), in step S732, communication voice is generated and provided to the participant. For example, the communication voice in step S732 may be “Jack's phone number is 6030. Please call back when the meal is ready.” It is understood that the communication voice in step S732 can be modified according to various requirements. In some embodiments, more interactions can be designed between the participants. For example, the communication voice in step S732 may be “Jack's phone number is 6030. Please call back when the meal is ready. Say yes to confirm.” If a response of “Yes” is received, communication voice, such as “Please repeat and confirm the order after the beep” is further generated and provided to the participant.

In the invention, the call management methods and systems integrating voice technologies such as the text-to-speech technology and the voice recognition technology can generate communication voices according to communication content, and provide it to the participant. Voice responses can be further received from the participant, and recognized, to automatically perform communication events accordingly, and provide related results to the phone user.

Call management methods and systems, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A call management method for use in a device having telecommunication capability, comprising:
providing at least one communication event comprising a phone number, first communication content and communication time;
making a call according to the phone number at the communication time;
generating first communication voice using a text-to-speech technology according to the first communication content; and
providing the first communication voice to at least one participant of the call.

2. The method of claim 1 further comprising:
receiving a first voice response corresponding to the first communication voice from the participant;
recognizing the first voice response using a voice recognition technology to obtain a first text response;
generating a first text message according to the first text response; and
displaying the first text message.

3. The method of claim 2 wherein the communication event further comprises a plurality of subsequent processes, and the method further comprises selecting a specific process from the subsequent processes according to the first text response.

4. The method of claim 3 wherein the specific process further comprises second communication content, and the specific process comprises:
generating a second voice according to the second communication content using the text-to-speech technology; and
providing the second communication voice to the participant.

5. The method of claim 4 further comprising:
receiving a second voice response corresponding to the second communication voice; and
recording the second voice response.

6. The method of claim 5 further comprising:
displaying a second text message indicating existence of the second voice response; and
setting a first specific key, where the second voice response is played back if a keystroke corresponding to the first specific key is received.

7. The method of claim 2 further comprising:
providing a third communication voice to the participant;
receiving a third voice response corresponding to the third communication voice;
recognizing the third voice response using the voice recognition technology to obtain a second text response;
generating a third text message according to the second text response; and
displaying the third text message.

8. The method of claim 7 further comprising providing a fourth communication voice to the participant to inform the participant to talk directly, or providing a fifth communication voice to the participant to inform the participant to leave a message according to the second text response.

9. The method of claim 7 further comprising talking to the participant directly or providing a sixth communication voice to the participant to inform the participant to leave a message if a keystroke corresponding to a second specific key is received.

10. The method of claim 1 further comprising making a call according to the phone number after a predetermined period if the call is not connected at the communication time.

11. The method of claim 10 further comprising displaying a fourth text message if the call is not connected at the communication time.

12. The method of claim 1 further comprising:
receiving a fourth voice response corresponding to the first communication voice from the participant;
recognizing the fourth voice response using the voice recognition technology to obtain a third text response;
in response to the third text response, generating a seventh communication voice using the text-to-speech technology according to third communication content in the communication event; and
providing the seventh communication voice to the participant.

13. The method of claim 12 further comprising:
providing at least one interface setting the third communication content at the communication time; and
making the call according to the phone number after the third communication content is set.

14. A call management method for use in a device having telecommunication and positioning capabilities, comprising:
providing at least one communication event comprising a phone number, first communication content and a communication location;
obtaining a position of the device;
making a call according to the phone number if the position conforms to the communication location;
generating first communication voice using a text-to-speech technology according to the first communication content; and
providing the first communication voice to at least one participant of the call.

15. The method of claim 14 further comprising:
receiving a first voice response corresponding to the first communication voice from the participant; and
recognizing the first voice response using a voice recognition technology to obtain a first text response.

16. A call management system for use in a device having telecommunication capability, comprising:
at least one communication event comprising a phone number, first communication content and communication time; and
a processing unit making a call according to the phone number at the communication time, generating first communication voice using a text-to-speech technology according to the first communication content, and providing the first communication voice to at least one participant of the call.

17. The system of claim 16 wherein the processing unit further receives a first voice response corresponding to the first communication voice from the participant, recognizes the first voice response using a voice recognition technology to obtain a first text response, generates a first text message according to the first text response, and displays the first text message.

18. The system of claim 17 wherein the communication event further comprises a plurality of subsequent processes, and the processing unit further selects a specific process from the subsequent processes according to the first text response.

19. The system of claim 18 wherein the specific process further comprises second communication content, and the processing unit further generates a second voice according to the second communication content using the text-to-speech technology, and provides the second communication voice to the participant.

20. The system of claim 19 wherein the processing unit further receives a second voice response corresponding to the second communication voice, and records the second voice response.

21. The system of claim 20 wherein the processing unit further displays a second text message indicating existence of the second voice response, and sets a first specific key, where the second voice response is played back if a keystroke corresponding to the first specific key is received.

22. The system of claim 17 wherein the processing unit further provides a third communication voice to the participant, receives a third voice response corresponding to the third communication voice, recognizes the third voice response using the voice recognition technology to obtain a second text response, generates a third text message according to the second text response, and displays the third text message.

23. The system of claim 22 wherein the processing unit further provides a fourth communication voice to the participant to inform the participant to talk directly, or provides a fifth communication voice to the participant to inform the participant to leave a message according to the second text response.

24. The system of claim 22 wherein the processing unit further makes the call directly talking to the participant or provides a sixth communication voice to the participant to inform the participant to leave a message if a keystroke corresponding to a second specific key is received.

25. The system of claim 16 wherein the processing unit further makes a call according to the phone number after a predetermined period if the call is not connected at the communication time.

26. The system of claim 25 wherein the processing unit further displays a fourth text message if the call is not connected at the communication time.

27. The system of claim 16 wherein the processing unit further receives a fourth voice response corresponding to the first communication voice from the participant, recognizes the fourth voice response using the voice recognition technology to obtain a third text response, generates a seventh communication voice using the text-to-speech technology according to third communication content in the communication even in response to the third text response, and provides the seventh communication voice to the participant.

28. The system of claim 27 wherein the processing unit further provides at least one interface setting the third communication content at the communication time, and makes the call according to the phone number after the third communication content is set.

29. A call management system for use in a device having telecommunication and positioning capabilities, comprising:
at least one communication event comprising a phone number, first communication content and a communication location; and
a processing unit obtaining a position of the device, making a call according to the phone number if the position conforms to the communication location, generating first communication voice using a text-to-speech technology according to the first communication content, and providing the first communication voice to at least one participant of the call.

30. The system of claim 29 wherein the processing unit further receives a first voice response corresponding to the first communication voice from the participant, and recognizes the first voice response using a voice recognition technology to obtain a first text response.

31. A machine-readable storage medium comprising a computer program, which, when executed, causes a device to perform a call management method, the method comprising:
providing at least one communication event comprising a phone number, first communication content and communication time;
making a call according to the phone number at the communication time;
generating first communication voice using a text-to-speech technology according to the first communication content; and
providing the first communication voice to at least one participant of the call.

32. A machine-readable storage medium comprising a computer program, which, when executed, causes a device to perform a call management method, the method comprising:
providing at least one communication event comprising a phone number, first communication content and a communication location;
obtaining a position of the device;
making a call according to the phone number if the position conforms to the communication location;
generating first communication voice using a text-to-speech technology according to the first communication content; and
providing the first communication voice to at least one participant of the call.
